(19) United States
(12) Patent Application Publication
(10) Pub. No.: US 2025/0284128 A1
(43) Pub. Date: Sep. 11, 2025

(54) DISPLAY DEVICE, OPTICAL SYSTEM, AND HEAD MOUNTED DISPLAY DEVICE

(71) Applicants: Samsung Display Co., LTD., Yongin-si (KR); Kyungpook National University Industry-Academic Cooperation Foundation, Daegu (KR)

(72) Inventors: Sang Ho KIM, Yongin-si (KR); Hak Rin KIM, Daegu (KR); Ju Hwa HA, Yongin-si (KR); Jin Hyeok SEO, Daegu (KR); Jung Yeop SHIN, Daegu (KR); Jae Won LEE, Daegu (KR); Ji Won LEE, Yongin-si (KR)

(21) Appl. No.: 19/070,322

(22) Filed: Mar. 4, 2025

(30) Foreign Application Priority Data
Mar. 6, 2024 (KR) 10-2024-0032054

(51) Int. Cl. G02B 27/01; G02B 27/09; G02B 27/28

(52) U.S. Cl. CPC G02B 27/0172; G02B 27/0955; G02B 27/283; G02B 27/286

(57) ABSTRACT

A display device includes a display unit including a first surface on which an image is displayed, and a second surface opposite to the first surface, a geometric phase lens, a polarized light change element between the first surface of the display unit and the geometric phase lens, and a lens portion between the polarized light change element and the geometric phase lens, and including a half mirror, a lens, and a reflector.

### CROSS-REFERENCE TO RELATED APPLICATION

The present application claims priority to, and the benefit of, Korean Patent Application No. 10-2024-0032054, filed on Mar. 6, 2024, in the Korean Intellectual Property Office, the entire disclosure of which is incorporated herein by reference.

### BACKGROUND

### 1. Field

The present disclosure generally relates to a display device, an optical system, and a head-mounted display device.

### 2. Description of the Related Art

Recently, as interest in information displays increases, research and development of display devices have been continuously conducted.

### SUMMARY

Embodiments provide a display device and a head-mounted display device, which can reduce or minimize the volume of a focus adjustable optical system, and which can lighten the weight of the focus adjustable optical system, thereby reducing or minimizing the fatigue of a user.

In accordance with an aspect of the present disclosure, there is provided a display device including a display unit including a first surface on which an image is displayed, and a second surface opposite to the first surface, a geometric phase lens, a polarized light change element between the first surface of the display unit and the geometric phase lens, and a lens portion between the polarized light change element and the geometric phase lens, and including a half mirror, a lens, and a reflector. The half mirror, the lens, and the reflector may be sequentially arranged.

The polarized light change element may include a linear polarizer, a first half-wave plate, and a first quarter-wave plate.

The first half-wave plate may be between the linear polarizer and the first quarter-wave plate.

The reflector may include a linear polarization dependence reflector.

The lens portion may further include a second quarter-wave plate between the lens and the linear polarization dependence reflector.

The display device may further include a third quarter-wave plate between the linear polarization dependence reflector and the geometric phase lens.

The reflector may include a circular polarization dependence reflector.

The display device may further include a second half-wave plate between the lens portion and the geometric phase lens.

In accordance with another aspect of the present disclosure, there is provided an optical system including a linear polarizer, a geometric phase lens, a first half-wave plate between the linear polarizer and the geometric phase lens, a first quarter-wave plate between the first half-wave plate and the geometric phase lens, a half mirror between the first quarter-wave plate and the geometric phase lens, a lens between the half mirror and the geometric phase lens, a reflector between the lens and the geometric phase lens, and a second half-wave plate between the reflector and the geometric phase lens.

The reflector may include a circular polarization dependence reflector.

The reflector may include a linear polarization dependence reflector.

The optical system may further include a second quarter-wave plate between the lens and the linear polarization dependence reflector.

The optical system may further include a third quarter-wave plate between the second half-wave plate and the geometric phase lens.

The first half-wave plate and the second half-wave plate may include a first substrate, a second substrate, and liquid crystals between the first substrate and the second substrate.

In accordance with still another aspect of the present disclosure, there is provided a head-mounted display device including a display unit, a geometric phase lens configured to be between the display unit and a pupil of a user, a linear polarizer between the display unit and the geometric phase lens, a first half-wave plate between the linear polarizer and the geometric phase lens, a first quarter-wave plate between the first half-wave plate and the geometric phase lens, and a lens portion between the first quarter-wave plate and the geometric phase lens, and including a half mirror, a lens, and a reflector.

The reflector may include a linear polarization dependence reflector.

The lens portion may further include a second quarter-wave plate between the lens and the linear polarization dependence reflector.

The head-mounted display device may further include a third quarter-wave plate between the linear polarization dependence reflector and the geometric phase lens.

The reflector may include a circular polarization dependence reflector.

### BRIEF DESCRIPTION OF THE DRAWINGS

Embodiments will now be described more fully hereinafter with reference to the accompanying drawings, although the embodiments may be embodied in different forms, and should not be construed as limited to the descriptions set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view schematically illustrating a display device in accordance with one or more embodiments of the present disclosure.

FIG. 2 is an exploded perspective view schematically illustrating the display device in accordance with one or more embodiments of the present disclosure.

FIG. 3 is a view schematically illustrating a display unit and an optical system in accordance with one or more embodiments of the present disclosure.

FIGS. 4, 5, 6, and 7 are views illustrating incident light and output light polarization degrees and light-advancing paths according to an operation of a polarized light change element in the optical system in accordance with one or more embodiments of the present disclosure.

FIG. 8 is a view schematically illustrating a display unit and an optical system in accordance with one or more embodiments of the present disclosure.

FIGS. 9, 10, 11, and 12 are views illustrating incident light and output light polarization degrees and light-advancing paths according to an operation of a polarized light change element in the optical system in accordance with one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that the present disclosure covers all modifications, equivalents, and replacements within the idea and technical scope of the present disclosure, that each of the features of embodiments of the present disclosure may be combined with each other, in part or in whole, and technically various interlocking and operating are possible, and that each embodiment may be implemented independently of each other, or may be implemented together in an association, unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

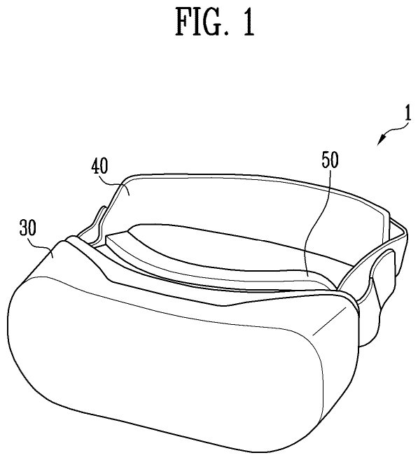

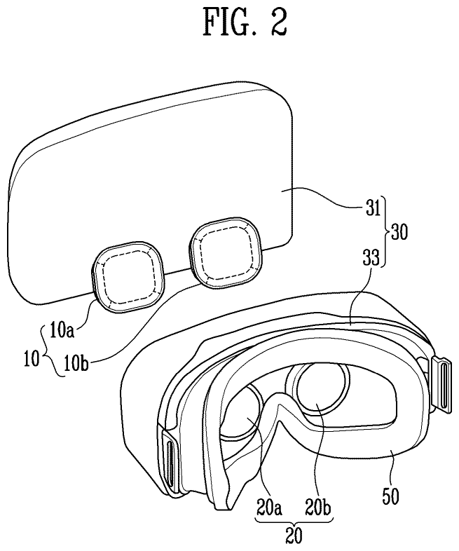

FIG. 1 is a perspective view schematically illustrating a display device in accordance with one or more embodiments of the present disclosure. FIG. 2 is an exploded perspective view schematically illustrating the display device in accordance with one or more embodiments of the present disclosure.

Referring to FIGS. 1 and 2, the display device 1 may include a head-mounted display device mounted on a head of a user to provide the user with a screen on which a picture or an image is displayed.

The display device 1 may include a see-through type that provides augmented reality, which may be based on actual external objects, and/or a see-closed type that provides virtual reality to the user with a screen independent from an external object. Hereinafter, a see-closed type head-mounted display device will be described as an example, but the present disclosure is not limited thereto.

Referring to FIGS. 1 and 2, the display device 1 may include a display unit 10, an optical system 20, a case portion 30, a fixing portion 40, and a cushion portion 50.

In one or more embodiments, the display unit 10 may display or provide an image. The display unit 10 may emit light to display or provide a picture or an image.

The display unit 10 may be accommodated in the case portion 30. The display unit 10 may be configured to be opaque, transparent, or translucent according to a type of the display device 1. The display unit 10 may include a display panel for displaying a picture or an image. The display unit 10 may include a light-emitting display panel including a light-emitting element. For example, the display unit 10 may include an organic light-emitting display panel using an organic light-emitting diode including an organic light-emitting layer, a micro light-emitting diode display panel using a micro light-emitting diode (LED), a quantum dot light-emitting display panel using a quantum dot LED including a quantum dot light-emitting layer, or an inorganic light-emitting display panel using an inorganic light-emitting element including an inorganic semiconductor.

In one or more embodiments, the display unit 10 may include a first display unit 10a and a second display unit 10b. The first display unit 10a may correspond to a left eye of the user, and the second display unit 10b may correspond to a right eye of the user.

In one or more embodiments, the display unit 10 may include a first surface (or front surface) on which an image is displayed, and a second surface (or rear surface) opposite to the first surface.

In one or more embodiments, the optical system 20 may allow light emitted from the display unit 10 to pass therethrough. The optical system 20 may refract and/or reflect light emitted from the display unit 10. The optical system 20 may face the display unit 10. When the user wears the display device 1, the optical system 20 may be located between the user and the display unit 10. Therefore, the user may recognize light that is emitted from the display unit 10, and that is refracted and/or reflected by the optical system 20.

In one or more embodiments, the optical system 20 may include a first optical system 20a and a second optical system 20b. The first optical system 20a may correspond to the left eye of the user, and may overlap with the first display unit 10a. The second optical system 20b may correspond to the right eye of the user, and may overlap with the second display unit 10b.

In one or more embodiments, the case portion 30 may accommodate the display unit 10 and the optical system 20 therein. The case portion 30 may be provided with a space therein, and the display unit 10 and the optical system 20 may be located in the space. The case portion 30 may protect the display unit 10 and the optical system 20 from external impact.

In one or more embodiments, the case portion 30 may include a cover portion 31 and a body portion 33. The case portion 30 may be separated into the cover portion 31 and the body portion 33. However, the present disclosure is not limited thereto, and the cover portion 31 and the body portion 33 may be integrally formed. In one or more embodiments, the cover portion 31 may be located on the rear surface of the display unit 10, and the body portion 33 may be located on the front surface of the display unit 10.

The fixing portion 40 may fix or mount the case portion 30 on the head of the user. A length of the fixing portion 40 may be adjusted according to a circumference of the head of the user. The fixing portion 40 may include a structure, such as a strap or a band, which is connected to the case portion 30. The fixing portion 40 may be detachable from the case portion 30.

In one or more embodiments, the cushion portion 50 may improve a wearing comfort to the user. When the user wears the display device 1, the cushion portion 50 may be located between the user and the case portion 30. For example, the cushion portion 50 may be attached to the case portion 30. For example, the cushion portion 50 may be detachable from the case portion 30, and may be omitted from the display device 1.

In one or more embodiments, the display device 1 may further include a control unit. The control unit may perform an operation for calculation of a position of a pupil of the user, calculation of a direction of a gaze of the user, image processing (or image mapping) based on the calculated position of the pupil of the user (or the calculated direction of the gaze of the user), display of a processed image on the display unit 10, and the like. The control portion may be implemented as a dedicated processor including an embedded processor or the like and/or a general-purpose processor including a central processing unit, an application processor, or the like. However, the present disclosure is not limited thereto.

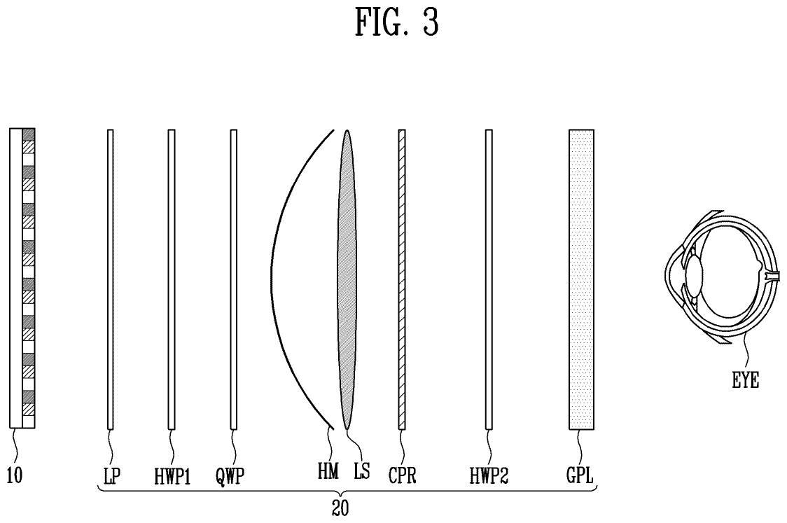

FIG. 3 is a view schematically illustrating a display unit and an optical system in accordance with one or more embodiments of the present disclosure.

Referring to FIGS. 1, 2, and 3, the optical system 20 may be located between the display unit 10 and a pupil EYE of a user. For example, the optical system 20 may be located between the first surface of the display unit 10, on which an image is displayed, and the pupil EYE of the user.

The optical system 20 may include a polarized light change element LP, HWP1, and QWP, a lens portion HM, LS, and CPR, and a geometric phase lens GPL.

The polarized light change element LP, HWP1, and QWP may be located on the first surface of the display unit 10. The polarized light change element LP, HWP1, and QWP may include a linear polarizer LP, a first half-wave plate HWP1, and/or a quarter-wave plate QWP.

The linear polarizer LP may be located on the first surface of the display unit 10. The linear polarizer LP may be located directly on the first surface of the display unit 10. The linear polarizer LP may polarize light in an unpolarized light state, which is emitted from the display unit 10, in a corresponding direction.

The first half-wave plate HWP1 may be located on the linear polarizer LP. The first half-wave plate HWP1 may be located directly on the linear polarizer LP. The first half-wave plate HWP1 may be located between the linear polarizer LP and the quarter-wave plate QWP.

The first half-wave plate HWP1 is a component which adjusts a polarization direction of light, and may delay a phase of transmitted light by λ/2. In one or more embodiments, the first half-wave plate HWP1 may be a liquid crystal element that is electrically switchable. For example, the first half-wave plate HWP1 may include a first substrate, a second substrate, and liquid crystals located between the first substrate and the second substrate, and a direction of polarized light may be changed by electrodes applied to both ends of the first substrate and the second substrate. Accordingly, the first half-wave plate HWP1 can be implemented as a selective switching module capable of changing a polarization characteristic of transmitted light, can decrease a focus variable distance for each step as electric high speed driving is possible, and can be used to design an optical system by considering visual characteristics of the user.

The quarter-wave plate QWP may be located on the first half-wave plate HWP1. The quarter-wave plate QWP may be located directly on the first half-wave plate HWP1. The quarter-wave plate QWP may delay a phase of transmitted light by λ/4. For example, the quarter-wave plate QWP is a component that changes linearly polarized light to circularly polarized light, and that changes circularly polarized light to linearly polarized light. Incident linearly polarized light may be polarized into left-handed circularly polarized light LCP advancing while rotating to the left with respect to an advancing direction, and right-handed circularly polarized light RCP advancing while rotating to the right with respect to the advancing direction according to properties of the incident linearly polarized light.

The lens portion HM, LS, and CPR may be a pancake lens. The lens portion HM, LS, and CPR may be located on the polarized light change element LP, HWP1, and QWP. The lens portion HM, LS, and CPR may be located directly on the polarized light change element LP, HWP1, and QWP. The lens portion HM, LS, and CPR may be located between the polarized light change element LP, HWP1, and QWP and the geometric phase lens GPL. For example, the lens portion HM, LS, and CPR may be located between the quarter-wave plate QWP and the geometric lens GPL.

The lens portion HM, LS, and CPR may include a half mirror HM, a lens LS, and/or a reflector CPR. As the reflector is provided in the lens portion HM, LS, and CPR, a focal plane may be formed at different distances, using the lens portion HM, LS, and CPR, according to polarization states of light incident onto the lens portion HM, LS, and CPR. The reflector may be a circular polarization dependence reflector CPR. The half mirror HM, the lens LS, and/or the circular polarization dependence reflector CPR may be sequentially located on the first surface of the display unit 10.

The half mirror HM may be located on the quarter-wave plate QWP. The half mirror HM may be located directly on the quarter-wave plate QWP. The half mirror HM may partially reflect incident light. For example, only about a half of light incident onto the half mirror HM may pass through the half mirror HM. The half mirror HM may include a semi-transmissive material. The half mirror HM may include metals, such as magnesium (Mg), silver (Ag), and/or aluminum (AI), but the present disclosure is not necessarily limited thereto. In one or more embodiments, the half mirror HM may have a curvature, but the present disclosure is not necessarily limited thereto.

The lens LS may be located on the half mirror HM. The lens LS may be located directly on the half mirror HM. The lens LS may be located between the half mirror HM and the circular polarization dependence reflector CPR. The circular polarization dependence reflector CPR may be located on the lens LS.

The geometric phase lens GPL may be located on the lens portion HM, LS, and CPR. The geometric phase lens GPL may be located between the lens portion HM, LS, and CPR and the pupil EYE of the user. For example, the geometric phase lens GPL may be located between the circular polarization dependence reflector CPR and the pupil EYE of the user.

As the geometric phase lens GPL varies a circular polarization state of incident light, a focal plane can be formed at different distances by using one geometric phase lens GPL. In addition, as the geometric phase lens GPL is used, the thickness of a thick lens based on general refraction can be decreased to a thickness of about a few micrometers, and thus the volume of the optical system 20 can be reduced or minimized and lightened.

In one or more embodiments, the optical system 20 may further include a second half-wave plate HWP2. The second half-wave plate HWP2 may be located on the lens portion HM, LS, and CPR. For example, the second half-wave plate HWP2 may be located on the circular polarization dependence reflector CPR. The second half-wave plate HWP2 may be located between the lens portion HM, LS, and CPR and the geometric phase lens GPL. For example, the second half-wave plate HWP2 may be located between the circular polarization dependence reflector CPR and the geometric phase lens GPL. The second half-wave plate HWP2 may be located directly on the circular polarization dependence reflector CPR, and the geometric phase lens GPL may be located directly on the second half-wave plate HWP2.

The second half-wave plate HWP2 is a component that adjusts a polarization direction of light, and may delay a phase of transmitted light by λ/2. In one or more embodiments, the second half-wave plate HWP2 may be a liquid crystal element that is electrically switchable. For example, the second half-wave plate HWP2 may include a first substrate, a second substrate, and liquid crystals located between the first substrate and the second substrate, and a direction of polarized light may be changed by electrodes applied to respective ends of the first substrate and the second substrate. Accordingly, the second half-wave plate HWP2 can be implemented as a selective switching module capable of changing a polarization characteristic of transmitted light, can decrease a focus variable distance for each step as electric high speed driving is possible, and can be used to design an optical system by considering visual characteristics of the user.

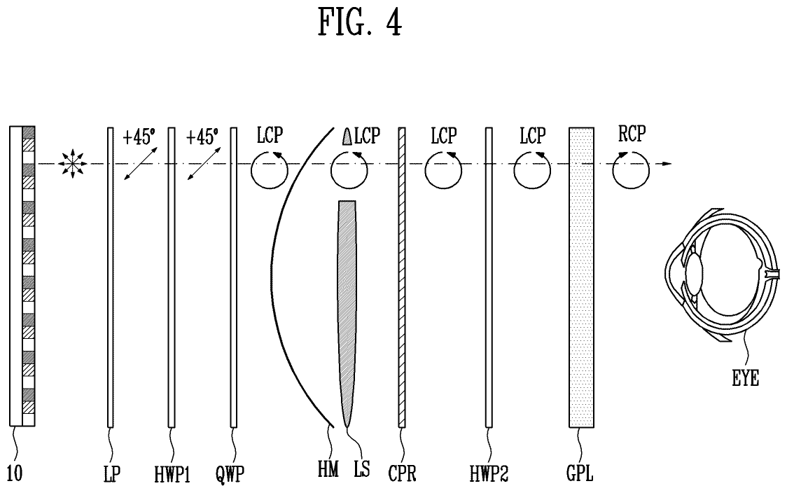

FIGS. 4, 5, 6, and 7 are views illustrating incident light and output light polarization degrees and light-advancing paths according to an operation of the polarized light change element in the optical system in accordance with one or more embodiments of the present disclosure.

FIG. 4 illustrates incident light and output light polarization degrees and a light-advancing path of each element if the first half-wave plate HWP1 does not operate and the second half-wave plate HWP2 does not operate.

Referring to FIG. 4, light output in an unpolarized light state from the display unit 10 may be changed to a linearly polarized component of 45 degrees while passing through the linear polarizer LP rotated at 45 degrees. Because linearly polarized light of 45 degrees is maintained as the first half-wave plate HWP1 does not operate, the light may be changed to left-handed circularly polarized light while being incident onto the quarter-wave plate QWP of 90 degrees. After the light passes through the half mirror HM, the polarized light state of the light may maintain a left-handed circularly polarized light state while the light passes through the half mirror HM and then passes through the circular polarization dependence reflector CPR. As the second half-wave plate HWP2 does not operate, the light may be changed to right-handed circularly polarized light while being incident in the left-handed circularly polarized light state onto the geometric phase lens GPL. Because the circularly polarized light state of the light incident onto the geometric phase lens GPL is the left-handed circularly polarized light state, the corresponding lens may operate as a convex lens.

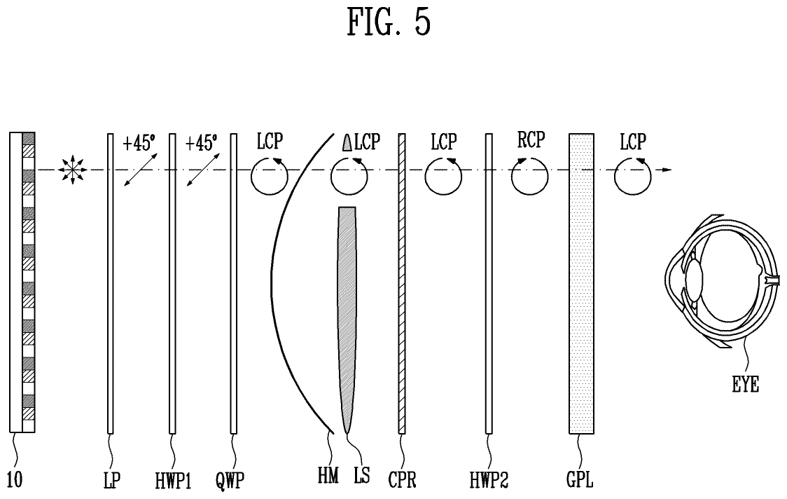

FIG. 5 illustrates incident light and output light polarization degrees, and a light-advancing path of each element if the first half-wave plate HWP1 does not operate and the second half-wave plate HWP2 operates.

Referring to FIG. 5, light output in an unpolarized light state from the display unit 10 may be changed to a linearly polarized component of 45 degrees while passing through the linear polarizer LP rotated at 45 degrees. Because linearly polarized light of 45 degrees is maintained as the first half-wave plate HWP1 does not operate, the light may be changed to left-handed circularly polarized light while being incident onto the quarter-wave plate QWP of 90 degrees. After the light passes through the half mirror HM, the polarized light state of the light may maintain a left-handed circularly polarized light state while the light passes through the half mirror HM, and then passes through the circular polarization dependence reflector CPR. As the second half-wave plate HWP2 operates, the polarized light state of the light may be changed from the left-handed circularly polarized light state to a right-handed circularly polarized light state, and the light may be changed to left-handed circularly polarized light while being incident in the right-handed circularly polarized light state onto the geometric phase lens GPL. Because the circularly polarized light state of the light incident onto the phase geometric phase lens GPL is the right-handed circularly polarized light state, the corresponding lens may operate as a concave lens.

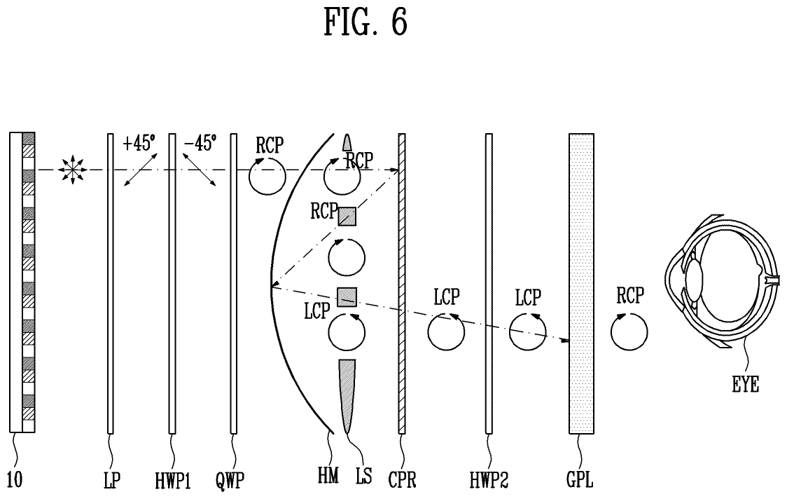

FIG. 6 illustrates incident light and output light polarization degrees and a light-advancing path of each element if the first half-wave plate HWP1 operates and the second half-wave plate HWP2 does not operate.

Referring to FIG. 6, light output in an unpolarized light state from the display unit 10 may be changed to a linearly polarized component of 45 degrees while passing through the linear polarizer LP rotated at 45 degrees. After linearly polarized light of 45 degrees is changed to linearly polarized light of −45 degrees as the first half-wave plate HWP1 operates, the light may be changed to right-handed circularly polarized light while being incident onto the quarter-wave plate QWP of 90 degrees. After the light passes through the half mirror HM, the light may be reflected by the circular polarization dependence reflector CPR when reflecting light in a right-handed circularly polarized light state to be re-reflected by the half mirror HM. The light may be reflected by the half mirror HM to pass through the circular polarization dependence reflector CPR while being changed to left-handed circularly polarized light. As the second half-wave plate HWP2 does not operate, the light may be incident in a left-handed circularly polarized light state onto the geometric phase lens GPL to be changed to the right-handed circularly polarized light. The circularly polarized light state of the light incident onto the geometric phase lens GPL is the left-handed circularly polarized light state, the corresponding lens may operate as a convex lens.

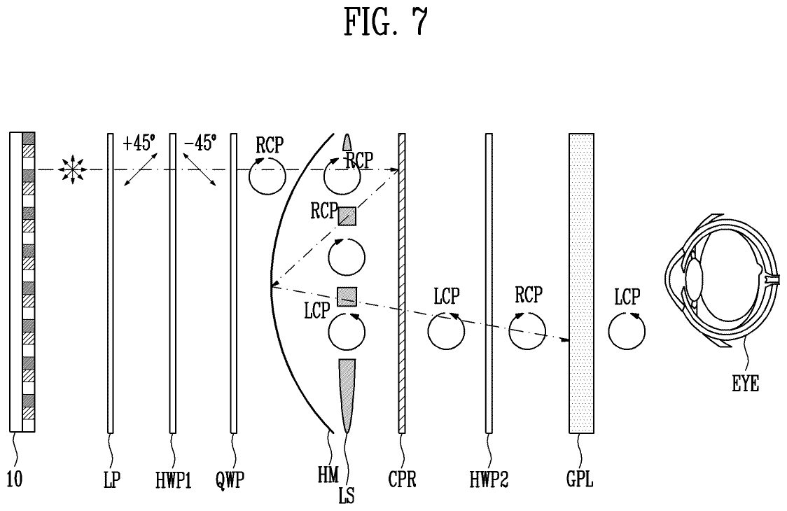

FIG. 7 illustrates incident light and output light polarization degrees and a light-advancing path of each element if the first half-wave plate HWP1 operates and the second half-wave plate HWP2 operates.

Referring to FIG. 7, light output in an unpolarized light state from the display unit 10 may be changed to a linearly polarized component of 45 degrees while passing through the linear polarizer LP rotated at 45 degrees. After linearly polarized light of 45 degrees is changed to linearly polarized light of −45 degrees as the first half-wave plate HWP1 operates, the light may be changed to right-handed circularly polarized light while being incident onto the quarter-wave plate QWP of 90 degrees. After the light passes through the half mirror HM, the light may be reflected by the circular polarization dependence reflector CPR when reflecting light in a right-handed circularly polarized light state to be re-reflected by the half mirror HM. The light may be reflected by the half mirror HM to pass through the circular polarization dependence reflector CPR while being changed to left-handed circularly polarized light. As the second half-wave plate HWP2 operates, the polarized light state of the light may be changed from a left-handed circularly polarized light state to the right-handed circularly polarized light state, and the light may be incident in the right-handed circularly polarized light state onto the geometric phase lens GPL to be changed to the left-handed circularly polarized light. Because the circularly polarized light state of the light incident onto the geometric phase lens GPL is the right-handed circularly polarized light state, the corresponding lens may operate as a concave lens.

The optical system 20 can generate two focal distances in the lens portion HM, LS, and CPR itself by controlling polarized light incident onto the circular polarization dependence reflector CPR according to the above-described method, and can adjust distances of 2ⁿ⁺¹ different focal planes according to a number n of geometric phase lenses GPL. In addition, the optical system is configured with a polarized light change element, one pancake lens, and one geometric phase lens, so that the number of elements inside the optical system can be reduced or minimized, thereby reducing the volume of the optical system, and thereby lightening the weight of the optical system. Accordingly, corresponding fatigue of the user can be reduced or minimized.

Hereinafter, one or more other embodiments will be described. Components identical to those that have already been described are designated by like reference numerals, and overlapping descriptions will be omitted or simplified.

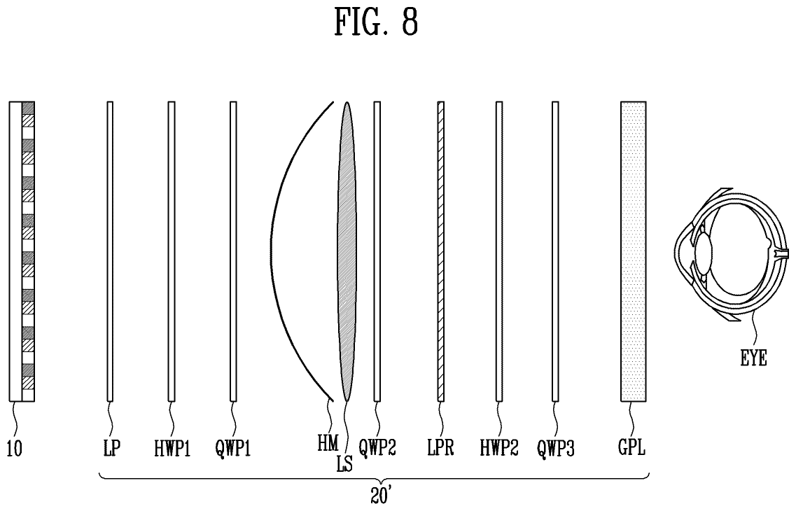

FIG. 8 is a view schematically illustrating a display unit and an optical system in accordance with one or more embodiments of the present disclosure.

Referring to FIG. 8, an optical system 20′ may be located between the display unit 10 and a pupil EYE of a user. For example, the optical system 20′ may be located between the first surface of the display unit 10, on which an image is displayed, and the pupil EYE of the user.

The optical system 20′ may include a polarized light change element LP, HWP1, and QWP1, a lens portion HM, LS, QWP2, and LPR, and a geometric phase lens GPL.

The polarized light change element LP, HWP1, and QWP1 may be located on the first surface of the display unit 10. The polarized light change element LP, HWP1, and QWP1 may include a linear polarizer LP, a first half-wave plate HWP1, and/or a first quarter-wave plate QWP1. The linear polarizer LP, the first half-wave plate HWP1, and/or the first quarter-wave plate QWP1 have been described in detail with reference to FIG. 3, and therefore, descriptions of overlapping portions will be omitted.

The lens portion HM, LS, QWP2, and LPR may be located on the polarized light change element LP, HWP1, and QWP1. The lens portion HM, LS, QWP2, and LPR may be a pancake lens. The lens portion HM, LS, QWP2, and LPR may be located between the polarized light change element LP, HWP1, and QWP1 and the geometric phase lens GPL. For example, the lens portion HM, LS, QWP2, and LPR may be located between the first quarter-wave plate QWP1 and the geometric phase lens GPL.

The lens portion HM, LS, QWP2, and LPR may include a half mirror HM, a lens LS, a second quarter-wave plate QWP2, and/or a reflector LPR. The reflector may be a linear polarization dependence reflector LPR. The half mirror HM, the lens LS, the second quarter-wave plate QWP2, and/or the linear polarization dependence reflector LPR may be sequentially located on the first surface of the display unit 10.

The second quarter-wave plate QWP2 may be located directly on the lens LS, and the linear polarization dependence reflector LPR may be located directly on the second quarter-wave plate QWP2. The second quarter-wave plate QWP2 may delay a phase of transmitted light by λ/4. For example, the second quarter-wave plate QWP2 is a component that changes linearly polarized light to circularly polarized light, and that changes circularly polarized light to linearly polarized light. Incident linearly polarized light may be polarized into left-handed circularly polarized light LCP advancing while rotating to the left with respect to an advancing direction, and right-handed circularly polarized light RCP advancing while rotating to the right with respect to the advancing direction according to properties of the incident linearly polarized light.

The geometric phase lens GPL may be located on the lens portion HM, LS, QWP2, and LPR. The geometric phase lens GPL may be located between the lens portion HM, LS, QWP2, and LPR and the pupil EYE of the user. For example, the geometric phase lens GPL may be located between the linear polarization dependence reflector LPR and the pupil EYE of the user.

In one or more embodiments, the optical system 20′ may further include a second half-wave plate HWP2. The second half-wave plate HWP2 may be located on the lens portion HM, LS, QWP2, and LPR. For example, the second half-wave plate HWP2 may be located on the linear polarization dependence reflector LPR. The second half-wave plate HWP2 may be located between the lens portion HM, LS, QWP2, and LPR and the geometric phase lens GPL. For example, the second half-wave plate HWP2 may be located between the linear polarization dependence reflector LPR and the geometric phase lens GPL.

In one or more embodiments, the optical system 20′ may further include a third quarter-wave plate QWP3. The third quarter-wave plate QWP3 may be located between the second half-wave plate HWP2 and the geometric phase lens GPL. The third quarter-wave plate QWP3 may be located directly on the second half-wave plate HWP2, and the geometric phase lens GPL may be located directly on the third quarter-wave plate QWP3.

The third quarter-wave plate QWP3 may delay a phase of transmitted light by λ/4. For example, the third quarter-wave plate QWP3 is a component that changes linearly polarized light to circularly polarized light, and that changes circularly polarized light to linearly polarized light. Incident linearly polarized light may be polarized into left-handed circularly polarized light LCP advancing while rotating to the left with respect to an advancing direction, and right-handed circularly polarized light RCP advancing while rotating to the right with respect to the advancing direction according to properties of the incident linearly polarized light.

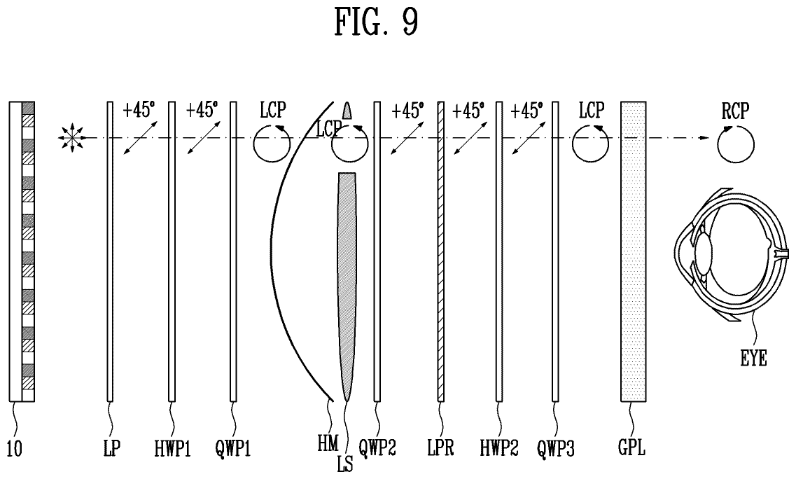

FIGS. 9, 10, 11, and 12 are views illustrating incident light and output light polarization degrees and light-advancing paths according to an operation of the polarized light change element in the optical system in accordance with one or more embodiments of the present disclosure.

FIG. 9 illustrates incident light and output light polarization degrees and a light-advancing path of each element if the first half-wave plate HWP1 does not operate and the second half-wave plate HWP2 does not operate.

Referring to FIG. 9, light output in an unpolarized light state from the display unit 10 may be changed to a linearly polarized component of 45 degrees while passing through the linear polarizer LP rotated at 45 degrees. Because linearly polarized light of 45 degrees is maintained as the first half-wave plate HWP1 does not operate, the light may be changed to left-handed circularly polarized light while being incident onto the first quarter-wave plate QWP1 of 90 degrees. After the light passes through the half mirror HM, the polarized light state of the light may be changed to a linearly polarized light state of 45 degrees while being incident onto the second quarter-wave plate QWP2 of 0 degrees. After that, the polarized light state of the light may maintain the linearly polarized light state of 45 degrees while passing through the linear polarization dependence reflector LPR, which allows light in the linearly polarized light state of 45 degrees to be transmitted therethrough, and which allows light in a linearly polarized light state of −45 degrees to be reflected therefrom. As the second half-wave plate HWP2 does not operate, the light may be changed to the left-handed circularly polarized light while being incident in the linearly polarized light state of 45 degrees onto the third quarter-wave plate QWP3 of 90 degrees, and then changed to right-handed circularly polarized light while being incident onto the geometric phase lens GPL. Because the circularly polarized light state of the light incident onto the geometric phase lens GPL is a left-handed circularly polarized light state, the corresponding lens may operate as a convex lens.

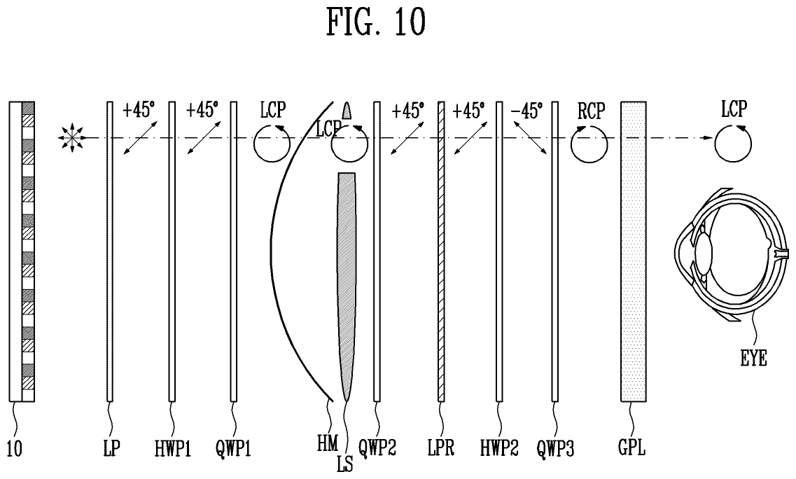

FIG. 10 illustrates incident light and output light polarization degrees and a light-advancing path of each element if the first half-wave plate HWP1 does not operate and the second half-wave plate HWP2 operates.

Referring to FIG. 10, light output in an unpolarized light state from the display unit 10 may be changed to a linearly polarized component of 45 degrees while passing through the linear polarizer LP rotated at 45 degrees. Because linearly polarized light of 45 degrees is maintained as the first half-wave plate HWP1 does not operate, the light may be changed to left-handed circularly polarized light while being incident onto the first quarter-wave plate QWP1 of 90 degrees. After the light passes through the half mirror HM, the polarized light state of the light may be changed to a linearly polarized light state of 45 degrees while being incident onto the second quarter-wave plate QWP2 of 0 degrees. After that, the polarized light state of the light may maintain the linearly polarized light state of 45 degrees while passing through the linear polarization dependence reflector LPR, which allows light in the linearly polarized light state of 45 degrees to be transmitted therethrough, and which allows light in a linearly polarized light state of −45 degrees to be reflected therefrom. As the second half-wave plate HWP2 operates, the light may be changed to right-handed circularly polarized light while being incident in a linearly polarized light state of −45 degrees onto the third quarter-wave plate QWP3 of 90 degrees, and then changed to the left-handed circularly polarized light while being incident onto the geometric phase lens GPL. Because the circularly polarized light state of the light incident onto the geometric phase lens GPL is a right-handed circularly polarized light state, the corresponding lens may operate as a concave lens.

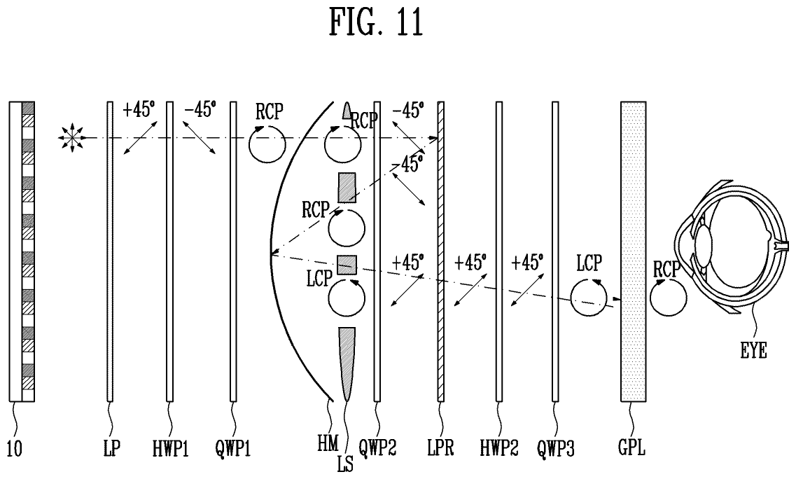

FIG. 11 illustrates incident light and output light polarization degrees and a light-advancing path of each element if the first half-wave plate HWP1 operates and the second half-wave plate HWP2 does not operate.

Referring to FIG. 11, light output in an unpolarized light state from the display unit 10 may be changed to a linearly polarized component of 45 degrees while passing through the linear polarizer LP rotated at 45 degrees. Because the light is changed to linearly polarized light of −45 degrees as the first half-wave plate HWP1 operates, the light may be changed to right-handed circularly polarized light while being incident onto the first quarter-wave plate QWP1 of 90 degrees. After the light passes through the half mirror HM, the polarized light state of the light may be changed to a linearly polarized light state of −45 degrees while being incident onto the second quarter-wave plate QWP2 of 0 degrees. After that, the light may be reflected by the linear polarization dependence reflector LPR, which allows light in the linearly polarized light state of 45 degrees to be transmitted therethrough, and which allows light in a linearly polarized light state of −45 degrees to be reflected therefrom to be changed to the right-handed circularly polarized light while a linearly polarized light component of −45 degrees is incident onto the second quarter-wave plate QWP2 of 0 degree, and may be reflected by the half mirror HM to be changed to left-handed circularly polarized light. After that, the light may be changed to a linearly polarized light component of 45 degrees while being incident onto the second quarter-wave plate QWP2 of 0 degrees to pass through the linear polarization dependence reflector LPR. As the second half-wave plate HWP2 does not operate, the light may be changed to the left-handed circularly polarized light while being incident in the linearly polarized light state of 45 degrees onto the third quarter-wave plate QWP3 of 90 degrees, and then changed to the right-handed circularly polarized light while being incident onto the geometric phase lens GPL. Because the circularly polarized light state of the light incident onto the geometric phase lens GPL is a left-handed circularly polarized light state, the corresponding lens may operate as a convex lens.

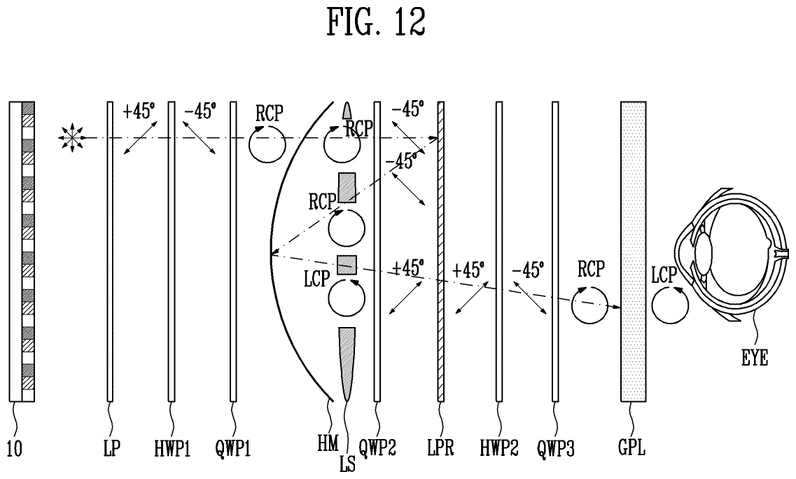

FIG. 12 illustrates incident light and output light polarization degrees and a light-advancing path of each element if the first half-wave plate HWP1 operates and the second half-wave plate HWP2 operates.

Referring to FIG. 12, light output in an unpolarized light state from the display unit 10 may be changed to a linearly polarized component of 45 degrees while passing through the linear polarizer LP rotated at 45 degrees. Because the light is changed to linearly polarized light of −45 degrees as the first half-wave plate HWP1 operates, the light may be changed to right-handed circularly polarized light while being incident onto the first quarter-wave plate QWP1 of 90 degrees. After the light passes through the half mirror HM, the polarized light state of the light may be changed to a linearly polarized light state of −45 degrees while being incident onto the second quarter-wave plate QWP2 of 0 degrees. After that, the light may be reflected by the linear polarization dependence reflector LPR, which allows light in the linearly polarized light state of 45 degrees to be transmitted therethrough, and which allows light in a linearly polarized light state of −45 degrees to be reflected therefrom to be changed to the right-handed circularly polarized light while a linearly polarized light component of −45 degrees is incident onto the second quarter-wave plate QWP2 of 0 degree, and may be reflected by the half mirror HM to be changed to left-handed circularly polarized light. After that, the light may be changed to a linearly polarized light component of 45 degrees while being incident onto the second quarter-wave plate QWP2 of 0 degrees to pass through the linear polarization dependence reflector LPR. As the second half-wave plate HWP2 operates, the light may be changed to the right-handed circularly polarized light while being incident in a linearly polarized light state of −45 degrees onto the third quarter-wave plate QWP3 of 90 degrees, and then changed to the left-handed circularly polarized light while being incident onto the geometric phase lens GPL. Because the circularly polarized light state of the light incident onto the geometric phase lens GPL is a right-handed circularly polarized light state, the corresponding lens may operate as a concave lens.

The optical system 20′ can generate two focal distances in the lens portion HM, LS, QWP2, and LPR itself by controlling polarized light incident onto the linear polarization dependence reflector LPR according to the above-described method, and can adjust distances of 2ⁿ⁺¹ different focal planes according to a number n of geometric phase lenses GPL. In addition, the optical system is configured with a polarized light change element, one pancake lens, and one geometric phase lens, so that the number of elements inside the optical system can be reduced or minimized, thereby reducing the volume of the optical system, and thereby lightening the weight of the optical system. Accordingly, corresponding fatigue of the user can be reduced or minimized, which is the same as described above.

In accordance with the present disclosure, the polarized light state inside the optical system is controlled, thereby adjusting distances of 2ⁿ⁺¹ (n is the number of geometric phase lenses) different focal planes. In addition, the optical system is configured with a polarized light change element, one pancake lens, and one geometric phase lens, so that the number of elements inside the optical system can be reduced or minimized, thereby reducing the volume of the optical system, and thereby lightening the weight of the optical system. Accordingly, corresponding fatigue of the user can be reduced or minimized.

Embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with any particular embodiments may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims, with functional equivalents thereof to be included therein.

What is claimed is:

1. A display device comprising:
a display unit comprising a first surface on which an image is displayed, and a second surface opposite to the first surface;
a geometric phase lens;
a polarized light change element between the first surface of the display unit and the geometric phase lens; and
a lens portion between the polarized light change element and the geometric phase lens, and comprising a half mirror, a lens, and a reflector.

2. The display device of claim 1, wherein the half mirror, the lens, and the reflector are sequentially arranged.

3. The display device of claim 1, wherein the polarized light change element comprises a linear polarizer, a first half-wave plate, and a first quarter-wave plate.

4. The display device of claim 3, wherein the first half-wave plate is between the linear polarizer and the first quarter-wave plate.

5. The display device of claim 3, wherein the reflector comprises a linear polarization dependence reflector.

6. The display device of claim 5, wherein the lens portion further comprises a second quarter-wave plate between the lens and the linear polarization dependence reflector.

7. The display device of claim 5, further comprising a third quarter-wave plate between the linear polarization dependence reflector and the geometric phase lens.

8. The display device of claim 3, wherein the reflector comprises a circular polarization dependence reflector.

9. The display device of claim 1, further comprising a second half-wave plate between the lens portion and the geometric phase lens.

10. An optical system comprising:
a linear polarizer;
a geometric phase lens;
a first half-wave plate between the linear polarizer and the geometric phase lens;
a first quarter-wave plate between the first half-wave plate and the geometric phase lens;
a half mirror between the first quarter-wave plate and the geometric phase lens;
a lens between the half mirror and the geometric phase lens;
a reflector between the lens and the geometric phase lens; and
a second half-wave plate between the reflector and the geometric phase lens.

11. The optical system of claim 10, wherein the reflector comprises a circular polarization dependence reflector.

12. The optical system of claim 10, wherein the reflector comprises a linear polarization dependence reflector.

13. The optical system of claim 12, further comprising a second quarter-wave plate between the lens and the linear polarization dependence reflector.

14. The optical system of claim 12, further comprising a third quarter-wave plate between the second half-wave plate and the geometric phase lens.

15. The optical system of claim 10, wherein the first half-wave plate and the second half-wave plate comprise a first substrate, a second substrate, and liquid crystals between the first substrate and the second substrate.

16. A head-mounted display device comprising:
a display unit;
a geometric phase lens configured to be between the display unit and a pupil of a user;
a linear polarizer between the display unit and the geometric phase lens;
a first half-wave plate between the linear polarizer and the geometric phase lens;
a first quarter-wave plate between the first half-wave plate and the geometric phase lens; and
a lens portion between the first quarter-wave plate and the geometric phase lens, and comprising a half mirror, a lens, and a reflector.

17. The head-mounted display device of claim 16, wherein the reflector comprises a linear polarization dependence reflector.

18. The head-mounted display device of claim 17, wherein the lens portion further comprises a second quarter-wave plate between the lens and the linear polarization dependence reflector.

19. The head-mounted display device of claim 17, further comprising a third quarter-wave plate between the linear polarization dependence reflector and the geometric phase lens.

20. The head-mounted display device of claim 16, wherein the reflector comprises a circular polarization dependence reflector.
